(19) United States
(12) Patent Application Publication
(10) Pub. No.: US 2016/0094637 A1
(43) Pub. Date: Mar. 31, 2016

(54) HIGH PERFORMANCE REAL-TIME INTERACTIVE EXPLORATION AND VISUALIZATION OF DISCRETE GEOSPATIAL DATA IN TIME AND SPACE

(71) Applicant: The United States of America, represented by the Secretary of Commerce, Silver Spring, MD (US)

(72) Inventors: Eric Hackathorn, Lafayette, CO (US); Jebb Stewart, Broomfield, CO (US); Jeff Smith, Westminster, CO (US); Julien Lynge, Louisville, CO (US)

(73) Assignee: The United States of America, represented by the Secretary of Commerce, Silver Spring, MD (US)

(21) Appl. No.: 14/866,716

(22) Filed: Sep. 25, 2015

Related U.S. Application Data
(60) Provisional application No. 62/057,905, filed on Sep. 30, 2014.

(51) Int. Cl. H04L 29/08; G06T 19/00; G06F 3/0481

(52) U.S. Cl. CPC H04L 67/1002; G06F 3/04815; G06T 19/006; G06T 2219/024

(57) ABSTRACT

A high performance real-time interactive exploration and visualization tool brings massive amounts of 4-D data, including output from multiple environmental forecast models as well as different data from different observations, in one place. Server side architecture provides a real-time stream processing system utilizing server-based Graphical Processing Units (GPU's) for data processing, wavelet based compression, and other preparation techniques for visualization, to minimize the bandwidth and latency for data delivery to end-users. Client side users interact through the visualization application developed using the Unity game engine and takes advantage of the GPU's allowing a user to interact with large data sets in real time. The invention improves accessibility to ‘Big Data’ and provides tools allowing novel visualization and seamless integration of data across time and space regardless of data size, physical location, or data format, allowing a user to see the global interactions and their importance for environmental prediction.

### CROSS-REFERENCE TO RELATED APPLICATIONS

The present application claims priority from Provisional U.S. Patent Application No. 62/057,905 filed on Sep. 30, 2014, and incorporated herein by reference.

### STATEMENT OF GOVERNMENT INTEREST

The research that led to the development of the present invention was sponsored by the National Oceanic and Atmospheric Administration. NOAA is a part of the U.S. Department of Commerce, a component of the U.S. Federal government. The United States Government has certain rights in this invention.

### FIELD OF THE INVENTION

The present invention relates to an interactive user interface and display and supporting data ingest infrastructure for use in graphically displaying weather data in real time. In particular, the present invention is directed toward an interface which allows a user to visually interpret weather data both in terms of space and time.

### BACKGROUND OF THE INVENTION

Predicting and forecasting weather and weather trends has been a goal of mankind for centuries. Due to the chaotic nature of our weather system, very complex computer models are required in order to predict world weather patterns and localized weather—as well as long-term trends. These models require extensive amounts of data, and various government agencies and private companies have expended considerable resources to collect such data.

Such data may include, but is not limited to, basic weather data such as temperature, wind velocity, wind direction, barometric pressure, humidity, and the like. Other data may include cloud radar data (from earth and satellite sources), satellite data (including image data in a number of visual and non-visual wavelengths). This data includes representations in both time and space—i.e., data for discrete locations on the planet at discrete time periods. Each data point may represent a data value (temperature, pressure, etc.) for a particular location or region at a particular point in time. As weather patterns and climate patterns occur over large areas over long periods time, an analyst may need to view such data in both terms of time and space.

Early weather prediction and forecasting models were somewhat primitive. Given the enormous amount of data involved, as well as the complex relationships between the data and weather patterns, as well as the chaotic nature of the weather system, computation of weather forecasts in early models may have taken hours or even overnight to process on early computers. Waiting hours or even minutes to view weather data or weather forecasts is not a workable solution if weather patterns and trends are to be successfully identified. A real-time solution for viewing weather data in terms of both time and space is required.

Graphical images of weather data are presently available for display, both online and for professionals in the weather forecasting and environmental sciences. Cloud patterns for localized areas may be viewed using Doppler radar and the like. Satellite imagery may capture cloud patterns which may be displayed to show weather patterns over time. However, usually, such displays are “stand alone” in that they display only one form of data (graphical image data) or limited numbers of other types of data. They are usually limited in terms of time coverage or area coverage.

For professional weather forecasters and weather scientists studying long-term weather trends, a graphical interface which allows for the display of layers of weather data, in terms of both time and space, in real-time, is required.

Other types of geographical data may also require such a graphical interface to allow a user to display layers of other types of data such as ecological, or ocean, or even social type data, which may vary geographically as well as temporally. A requirement remains in the art to be able to display and interact with such data, both spatially and temporally.

User interfaces exist which show global images and allow a user to zoom or relocate their viewpoint to different parts of the globe. Google Earth™ by Google, Inc. of Mountain View, Calif., is an example of one such graphical user interface. A user may view different parts of the globe, zoom to different areas, and even magnify images down to street level. However, the Google Earth interface was not designed for weather use, but for geography and mapping. The image data stored in the database is that from cloudless days only, and is not selectable in terms of time.

Another Prior Art interface which allows a user to view the Earth (and other planets) from various vantage points and altitudes is the mobile application “Solar Walk” (http://vitotechnology.com/solar-walk.html) which is an application for iPads and iPhones. The application allows a user to view planets, stars, and even satellites (man-made and natural) from different vantage points. Note the use of a “time line” which may be used to see how the Earth looks from a particular satellite. However, the time-based data is stored canned data, and thus of no use to a researcher, as it does not provide a selection of data from different discrete and measured times.

Thus, it remains a requirement in the art to provide a graphical user interface which allows a user to view weather data in a global graphical format, with the ability to select location, time, data type, and the like, in real-time.

### BRIEF SUMMARY OF THE INVENTION

The present inventors have created a high-performance real-time interactive exploration and visualization tool, known as TerraViz™, which brings massive amounts of 4-D data, including output from multiple environmental forecast models as well as different data from different observations (surface observation, upper air, maritime observation) into one user-friendly interactive display tool.

Server side architecture provides a real-time stream processing system, which utilizes server-based Graphical Processing Units (GPU's) for data processing, wavelet based compression, and other preparation techniques for visualization, to minimize the bandwidth and latency for data delivery to end-users.

On the client side, users interact through the visualization application developed using the Unity game engine, which takes advantage of the GPU's allowing a user to interact with large data sets in real time that might not have been possible before.

Through these technologies, the inventors have improved accessibility to ‘Big Data’ along with providing tools allowing novel visualization and seamless integration of data across time and space, regardless of data size, physical location, or data format. These capabilities provide the ability to view how the data types relate over time as well as spatially to see the global interactions and their importance for environmental prediction. Additionally, they allow greater access than currently exists helping to foster scientific collaboration and new ideas.

### BRIEF DESCRIPTION OF THE SEVERAL VIEWS OF THE DRAWINGS

FIG. 1 is a screen shot illustrating the major components of the time and height wheels, used to control data views for different times and heights.

FIG. 2 is a screen shot illustrating time matching across multiple data sets.

FIG. 3 is a screen shot illustrating time and height wheels, showing the FIM model at 500 mb in 2010 where blue frames are loaded in TerraViz™ while shaded frames are available on a remote server.

FIG. 4 is a screen shot illustrating multiple times or heights, where step 1 unlocks a particular wheel, and step 2 slides the specific data set up or down in time, to generate a separate colored “current time triangle”; step 3 creates a wheel header that corresponds to the triangle from step 2, which allows the same data to be viewed at multiple time steps.

FIG. 5 is a flowchart illustrating user interaction with the time wheel.

FIG. 6 is a flowchart illustrating the steps in the process when a local request is made for data.

FIG. 7 is a flowchart illustrating the steps in a local request for contour data.

FIG. 8 is a flowchart illustrating the process for changing the display time.

FIG. 9 is a flowchart illustrating the process of changing the time magnitude.

FIG. 10 is a flowchart illustrating the process of time matching.

FIG. 11 is a simplified block diagram illustrating the basic components of the present invention.

### DETAILED DESCRIPTION OF THE INVENTION

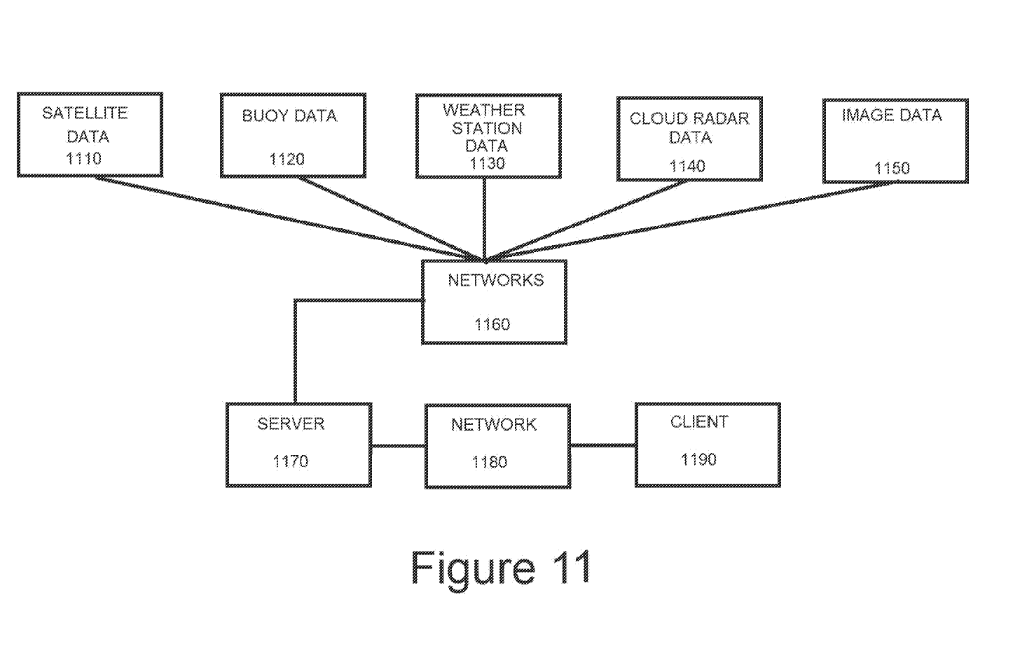

FIG. 11 is a simplified block diagram illustrating the basic components of the present invention. Referring to FIG. 11, data from a number of sources 1110-1150 may be collected and sent via networks 1160 (satellite links, internet, proprietary networks, and the like) to a server 1170 where such data may be stored and processed. In cases that do not involve additional processing of the data, metadata may be collected and stored on server 1170. The actual data is retained on sources 1110-1150. The client connects server 1170 asking what data is available and then makes a direct connection to data sources 1110-1150 for actual data.

Data sources may include but are not limited to Satellite data (e.g., Satellite weather data) 1110, Buoy data 1120 (e.g., wind direction and speed, temperature, barometric pressure, water temperature, and the like), Weather Station data 1130 (e.g., wind direction and speed, temperature, barometric pressure, doppler radar data, and the like), Cloud Radar data 1140 (e.g., from remote cloud radar data stations), and image data 1150 (e.g., satellite image data of the Earth's surface and the like). Again, other sources of data may also be included.

Portions of the system of FIG. 11 may comprise components of the NEIS system. NEIS is the NOAA Earth Information System. Many of concepts of the present invention stem from this project. Most or all the server side components are NEIS implementations whereas TerraViz™ implements the concepts for visualization of the resultant data. The two work in very close tandem to help implement what is described in present invention.

This data may be stored in server 1170 and then processed in response to requests from client 1190, which may communicate with server 1170 over network 1180, which may comprise the Internet, a local network, a proprietary network, or the like. As will be described in more detail below, when a client 1190 requests data for different spatial and temporal regions or ranges, server 1170 may process and transmit such metadata to client 1190 which in turn requests data from data sources 1110-1150 in a manner that allows client 1190 to display and scroll through data visually, in both terms of space and time. If derivative data products are required to complete the request from client 1190, source data from data sources 1110-1150 may be downloaded to server 1170 for additional processing. Client 1190 may also request that this processing takes place remotely.

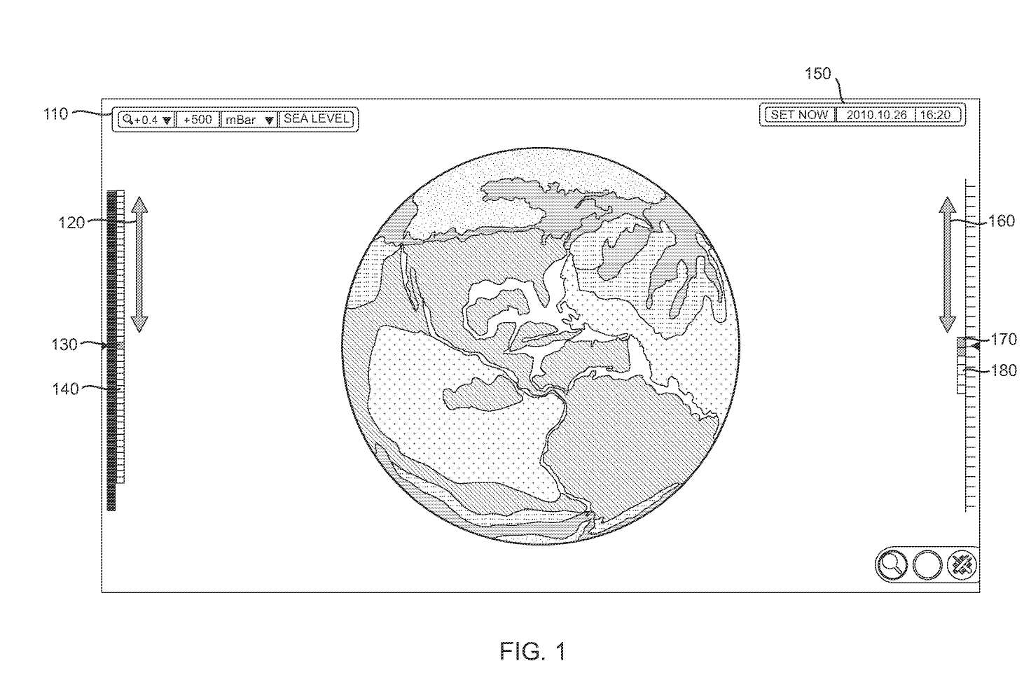

FIG. 1 is a screen shot illustrating the major components of the time and height wheels, used to control data views for different times and heights. FIG. 1 illustrates one example of the user interface of the present invention. In this example, atmospheric temperature data is being displayed graphically (in terms of color) for various heights (altitudes) as well as time periods, over a global view of the Earth.

Referring to FIG. 1, element 110 of the display shows the current height/pressure and selected zoom level. This display item shows the user the current height (altitude in kilometers, miles, feet, or the like, or sea level, as shown in FIG. 1), atmospheric pressure (in millibars, inches of mercury, or the like) as well as zoom level (+0.4 in this example). Element 120 illustrates how the height wheel (on the left side of the display) may be scrolled up and down by the user (using a mouse, touchscreen, or the like) to adjust the height (altitude) of the displayed data. Element 140 of the display represents the available frames of temperature (or other atmospheric data, depending on a user's selection) data (in this example) which are available from the server or data sources. The darker portion 130 of element 140 shows which frames of temperature data are currently loaded in the client computer, while the lighter portions represent frames available on the server or from the data sources. Again, in this example, atmospheric temperature data is being displayed graphically, but other types of data may also be displayed, such as wind direction, pressure, cloud cover, humidity, or the like.

Element 160 of FIG. 1 shows the current time and selected time magnitude. Element 160 illustrates how the time wheel, shown on the right hand side of the display, may be adjusted by the user (using a mouse, touchscreen, or the like) to adjust the time of the displayed data. By moving the time wheel, the user can see how atmospheric temperature patterns (in this example) change on the planet display, over time. Available frames of time data 180 (available on the server) is shown next to the time wheel. Loaded frames of time data 170 is shown in a darker color. In this manner, the user can see visually, what time data is available from the server (or data sources), and what time data is presently loaded into the client device, as will be discussed in more detail below.

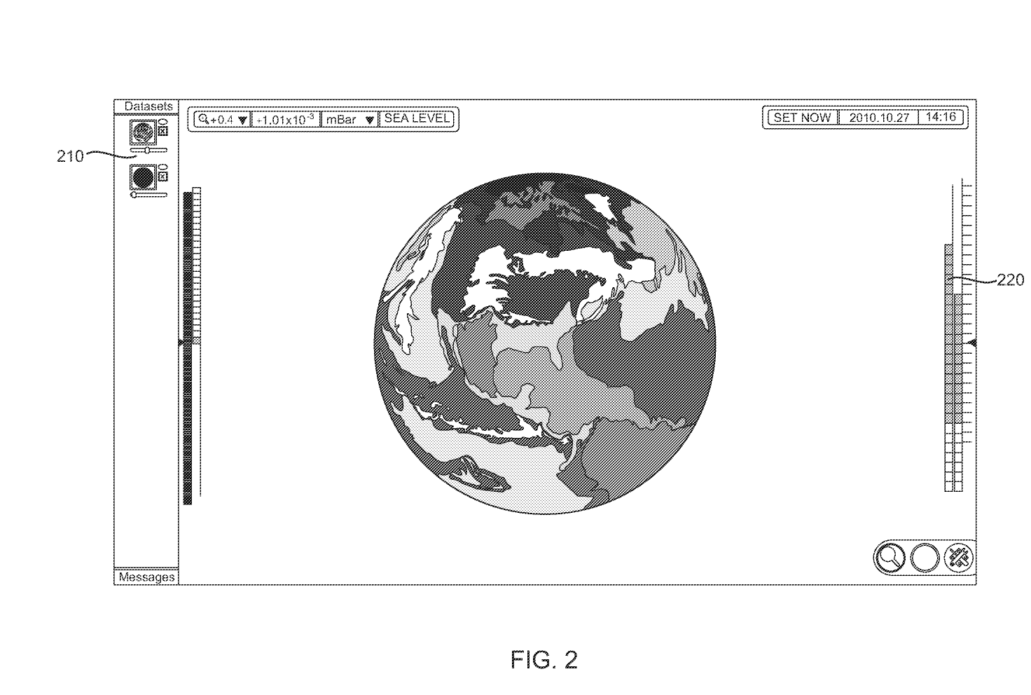

FIG. 2 is a screen shot illustrating time matching across multiple data sets. Referring to FIG. 2, data set layers 210 may be reordered and settings modified. Multiple types of data may be displayed at the same time, in graphical format, on the visual display, which in this example, is the global view. As illustrated in FIG. 2, the multiple data sets are time-matched and displayed 220 next to the time wheel. Thus different data sets and different data types can be aligned and displayed on the display, and the user can then adjust the time wheel to move back and forth in time to view how the data types relate over time as well as spatially.

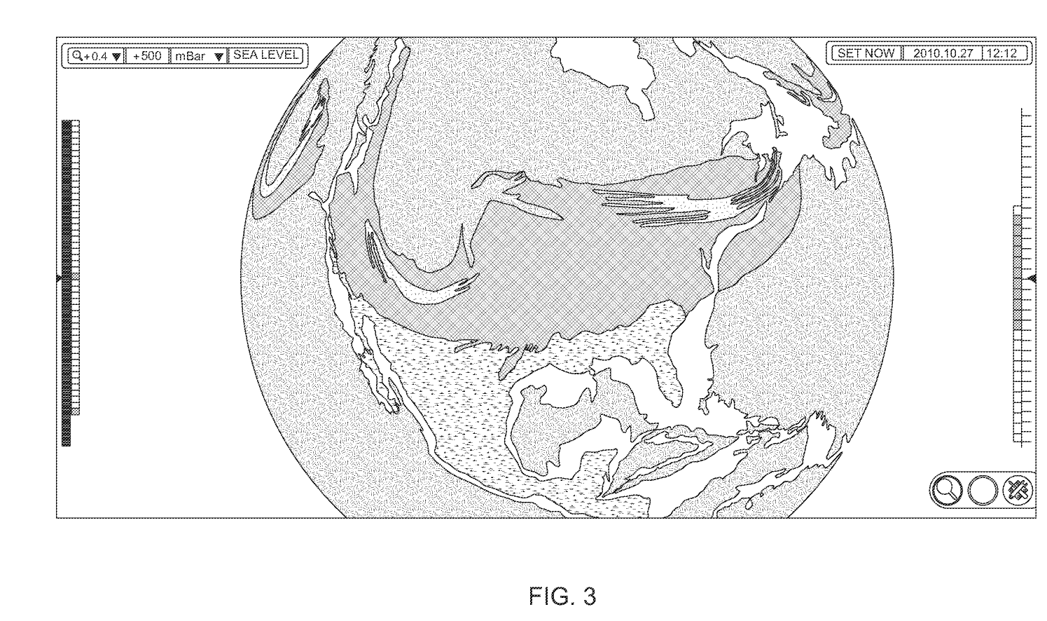

FIG. 3 is a screen shot illustrating time and height wheels, showing the FIM model at 500 mb in 2010 where shaded frames (on the time and height wheels) are loaded in TerraViz™ while white frames (on the time and height wheels) are available on a remote server or from a data source. FIG. 3 illustrates how different types of data may be superimposed onto a display, in this case wind speed and direction, as well as atmospheric temperature.

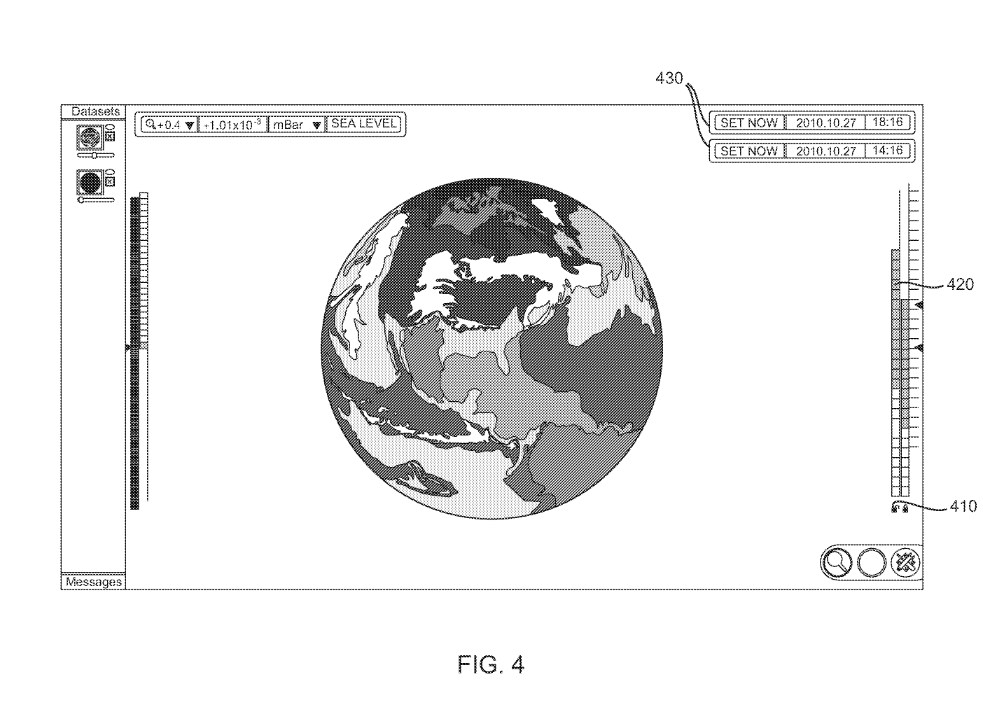

FIG. 4 is a screen shot illustrating multiple times or heights, where icon 410 unlocks a particular wheel (in this instance, the time wheel), and icon 420 slides the specific data set up or down in time, to generate a separate colored “current time triangle” indicating the current time frame being viewed. Icon 430 creates a wheel header that corresponds to the triangle from icon 420.

The “Base” program (i.e., TerraViz™) is an application comprising a geospatial map background; where all details are rendered using the General Processing Unit (GPU), through the use of the Unity3d Game Engine (http://unity3d.com/), made by Unity Technologies of San Francisco, Calif., allowing user to rotate, slide, move to any geospatial location; user can zoom in or out to display more or less of information available. The use of 3D gaming software for weather data applications is unique and non-intuitive.

The TerraViz™ application allows one or more overlays. Overlays comprise representations of data in image, vector, barb, streamline, particles, kml, or other graphic or rendered format, aligned in both time (temporally) and space (geospatially). Overlays are geospatial matched regardless of display projection (e.g., Mercator, lambert conformal, or the like). Geospatial data is mapped to the current display projection (e.g., Mercator, Sphere, Lambert Conformal, LatLon, or the like). Overlays are temporal matched regardless of temporal interval, a feature which has not been attempted in Prior Art displays.

Once the Overlay is displayed and available to a user, the user can dynamically adjust opacity, allowing the user to see other overlays underneath. An overlay can be unloaded if no longer of interest to user. Projection can be changed to any one of other available projections (e.g., Mercator, Sphere, Lambert Conformal, LatLon, or the like) and overlays currently displayed are automatically re-projected to new projection format.

One unique feature of the present invention is the Time Wheel 160 as discussed previously in connection with FIG. 1. Overlays comprising a time series (or series of graphics over time) are automatically aligned in chronological order and accessible through the use of the user interface element Time Wheel 160. Note that Time Wheel 160 is not wheel-shaped in the display, but represents an end-view of the wheel, which may be scrolled up and down by the user. The Time Wheel 160 allows the user to change the time striding (i.e., step through time in minutes, hours, days, months, or the like). The Time Wheel 160 allows the user to drag to change the time of the current overlay displayed; as the time is changed the corresponding overlays associated with the current time bin are displayed to user. Time Wheel 160 can be set to automatically advance through subsequent times determined by striding, and overlays are updated accordingly. Automatic advancement can occur in either forward or reverse directions. The Time Wheel provides the user full access to entire temporal extent of overlays available.

Overlays, which are unique to the present invention, comprise vertical layers which are automatically aligned in order, and accessible through the use of a user interface element known as the Height Wheel 120 as described above in connection with FIG. 1. Note that Height Wheel 160 is not wheel-shaped in the display, but represents an end-view of the wheel which may be scrolled up and down by the user. Height Wheel 120 allows the user to change the height striding (step through height in 1×, 10×, 100× units). The Height Wheel 120 allows the user to drag to change the current vertical level of the overlay displayed. As the vertical level is changed, the corresponding overlays associated with the current vertical bin are displayed to the user. Regardless of number of vertical levels or geospatial location of levels, the user has full access to the entire vertical extent of overlays available.

Data Blooming may be utilized when overlays available to a client exceed available memory in a client's machine and to prioritize the download of remote overlays. To overcome this issue, overlay loading is accomplished in the following ways. The application queries the remote server providing the overlays to determine the temporal (time steps), and geospatial extents (vertical levels). This information is indicated to user on both the Time Wheel 160 and Height Wheel 120. The user selects a desired time and vertical level, and the application begins to load the overlay for the specified vertical level by loading the closest overlays to the desired time. As the overlays are loaded and displayed to user, the next grouping of additional overlays closest to the current time are loaded. This process repeats until a percentage of memory available to the application is exhausted or the entire temporal extent has been loaded. When the user changes either the vertical level or the desired time to display, the process repeats using the current desired time and vertical level. If memory becomes exhausted during any of these steps, the data furthest from the specified time or vertical level is dynamically unloaded. This allows the user to keep the maximum relevant data in memory and display.

Multi Pane views are also possible. Initial overlays are contained within a single frame. A user may specify to duplicate base projection into one or more panes. Panes are linked so that geospatial navigation is the same within each pane. The form application method allows the user to drag icons to one or more panes allowing the duplicate display of overlay to this pane. This feature is unique to this invention.

The overlay may be offset as well as unlocked. Default behavior locks each overlay and pane to the same vertical level, geospatial location, or time. The application and icon allows the user to unlock the layers and create and offset. Overlays may be offset in a number of ways. Overlays may be offset in a vertical extent such that overlays are displayed at two or more vertical levels simultaneously. Overlays may be offset in a temporal extent such that overlays are displayed at two or more time steps simultaneously. Overlays may be offset in a geospatial extent such that overlays are displayed at two or more geospatial locations simultaneously. Overlays can be reset and locked back to original vertical level, or specified time, or geospatial location if desired.

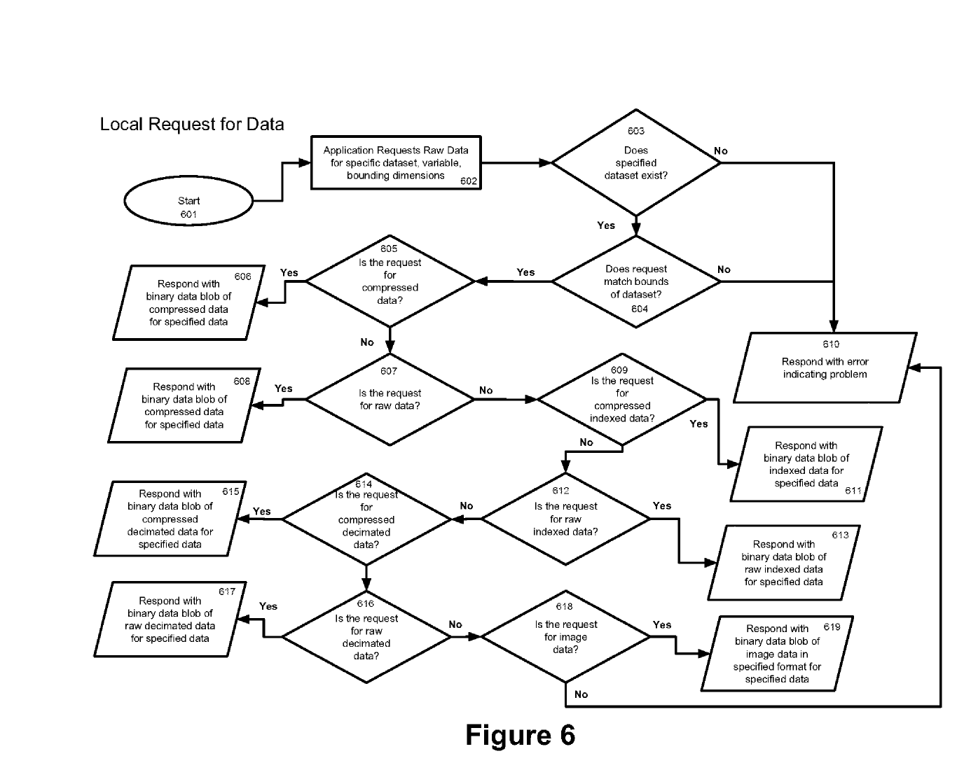

Remote data access may be provided on the server side. A remote service may be accessible through a defined Application Program Interface (API), that allows an application to request a slice of 4-Dimensional (x,y,z,t) data. Data may be requested as raw array of floats, compressed using wavelet, or compressed using run-length encoding (zip). Using this service client, the user may request data be rendered on the server side into an overlay of either image (JPG, PNG, DXT) format or contoured into vector graphic representation, as will be discussed in more detail below in connection with the flowchart of FIG. 6.

Dynamic data overlay generation may also be provided on the server side. In addition to data which exists as stored content on remote server, a client may request a process (algorithm) to be run on one or more remote data sets to dynamically generate new data, with said data being rendered in the ways described above. The algorithm specified by user above is run either on the computer Central Processing Units (CPU), or if available, Graphical Processing Units (GPU) within server side hardware.

The algorithms may be written in multiple programming languages (polyglot) to allow users to create custom algorithms in a programming language they are more familiar with. The algorithms define parameters needed along with a User Interface (UI) specifications allow the remote client to automatically generate the UI for each individual algorithm.

The unique use of wavelet compression reduces the size of data transferred. The client and server can exchange information using wavelet compression. Data is stored on the server side using wavelet compression. Upon request, a tile from data is generated by assembling data from wavelet compressed data. If the user requests more detail for a given area of data already received, (i.e., zooms in) and the user already has low pass filter information for the image (previous displayed image), a request is made for the wavelet high pass filter information only, using this information the higher level of detail image is created. This process can repeat until the image level of detail matches the original level of detail for the particular data set. This eliminates sending redundant information to the client for each increased level of detail request from client.

Stream-based data processing of large arrays of data may be performed on the server side. As data arrives on the server side from disparate sources, data is then streamed to worker processes performing various functions allowing near real-time processing of large arrays of geospatial environmental information. Upon receipt, data is broken into smaller arrays based on vertical levels available in the underlying data set and sent into the stream.

A worker process is responsible for a single concise action, and only performs this action if metadata passed along with data matches the worker's criteria. Worker processes may include the following functions: reading an individual vertical layer from disk, extracting metadata, generating derived product, run-length compression, wavelet compression, and forwarding data to remote client subscribed for updates to a particular data set.

Wavelet compression, as previously discussed, is performed on the GPU processor within the server environment. Derived products may be generated on a server side GPU to improve speed of creation.

The data interface of the present invention is designed for a world where everything is in motion. The invention allows fluid data integration and interaction across 4D time and space, providing a seamless experience across multiple data domains. There are no known interfaces presently on the market which accomplish the same goal in a seamless manner.

Competing tools include tools such as Google Earth, however, this tool has limited animation support, limited support for non-static data (i.e., time series) and can't handle large data volumes. In addition, Google Earth is not adapted to handle weather and atmospheric data, but rather displays only static map and image data, often many months or even years out of date. In fact, since Google Earth is directed toward map and land image data, images with clouds are often edited from the database. Google Earth does not allow for both spatial and temporal scrolling of an image. Other systems offer limited data discovery and access, often requiring another application to find new data. Synchronizing and animating data from different services is difficult and there is limited support for cross data source interrogation.

Any geospatial application that wishes to seamlessly view diverse data sets could benefit from this invention. Existing tools on the market do not have an interface that is as flexible or as responsive as the proposed solution.

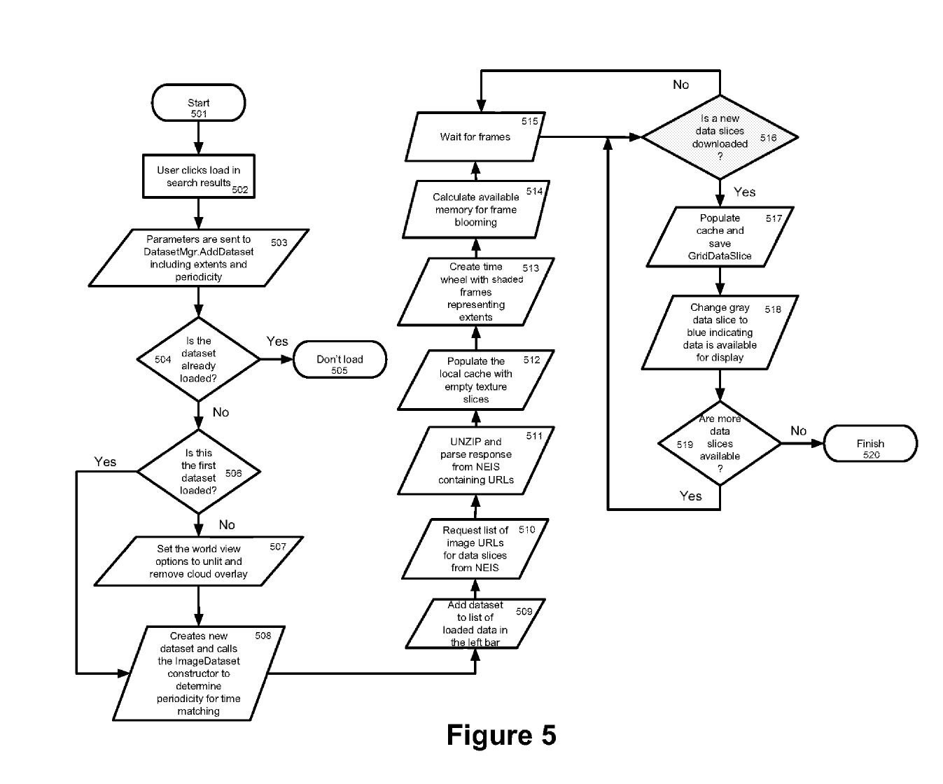

FIGS. 5-10 are flowcharts illustrating the steps in the various processes used by the interface of the present invention.

FIG. 5 is a flowchart illustrating user interaction with the time wheel. The time wheel provides user full access to entire temporal extent of overlays available. The time wheel allows the user to perform a number of functions. The user may use the time wheel to change the time striding (i.e., step through time in minutes, hours, days, months etc). The user may drag the time wheel to change the time of the current overlay displayed. As the time is changed, the corresponding overlays associated with the current time bin may be displayed to the user. The time wheel may be set to automatically advance through subsequent times determined by striding, and overlays may be updated accordingly. Automatic advancement may occur in either forward or reverse directions.

Referring to FIG. 5, in step 501 the process is started. In step 502, a user clicks to load in search results. In step 503, parameters are sent to DatasetMgr.AddDataset including extents and periodicity. In step 504, a determination is made whether the dataset is already loaded. If the data set is already loaded, then in step 505, the data is not reloaded. If the data set is not loaded, in step 506, a determination is made whether this is the first dataset loaded. If YES, processing passes to step 508 discussed below. If NO, then the system sets the world view options to unlit in step 507 and removes the cloud overlay from the display and the processing passes to step 508.

In step 508, the system creates a new dataset and calls the ImageDataset constructor to determine periodicity for time matching. Processing then passes to step 509 where the dataset is added to the list of loaded data in the left bar. Processing then passes to step 510 where a request is made for a list of image URLs for data slices from NEIS. Processing then passes to step 511 where the response from the NEIS containing URLs is UNZIPPED and parsed. Processing then passes to step 512 where the local cache is populated with empty texture slices. Processing then passes to step 513 where the time wheel is created with shaded frames representing extents. Processing then passes to step 514 where available memory is calculated for frame blooming. Processing then passes to step 515 to wait for frames.

Processing then passes to step 516 where a determination is made whether a new data slice is downloaded. If NO, processing returns to step 515 to wait for frames. If YES, processing passes to step 517 where cache is populated and a grid data slice GridDataSlice is saved. Processing then passes to step 518 where the corresponding shaded data slice is changed to blue, indicating data is available for display. In step 519 a determination is made whether more data slices are available. If NO, the process is finished in step 520. If YES, processing returns to step 516.

FIG. 6 is a flowchart illustrating the steps in the process when a local request is made for data. Referring to FIG. 6, in step 601, the process is started. In step 602, the Application requests raw data for a specific dataset, variable, and bounding dimensions. In step 603, a determination is made whether the specified dataset exists. If NO, then processing passes to step 610, where the system responds with an error message indicating a problem.

If YES, then processing passes to step 604, where a determination is made whether the request matches the bounds of the dataset. If NO, then processing passes to step 610, where the system responds with an error message indicating a problem. Is YES, then processing passes to step 605. In step 605 a determination is made whether the request is for compressed data. If YES, then processing passes to step 606 where the system responds with a binary data blob of compressed data for the specified requested data.

If NO, then processing passes to step 607, where a determination is made whether the request is for raw data. If YES, then processing passes to step 608 where the system responds with a binary data blob of raw data for the specified requested data. If NO, then processing passes to step 609, where a determination is made whether the request is for compressed indexed data.

If YES, then processing passes to step 611 where the system responds with a binary data blob of indexed data for the specified requested data. If NO, then processing passes to step 612, where a determination is made whether the request is for raw indexed data.

If YES, then processing passes to step 613 where the system responds with a binary data blob of raw indexed data for the specified requested data. If NO, then processing passes to step 614, where a determination is made whether the request is for compressed decimated data.

If YES, then processing passes to step 615 where the system responds with a binary data blob of compressed decimated data for the specified requested data. If NO, then processing passes to step 616, where a determination is made whether the request is for raw decimated data.

If YES, then processing passes to step 617 where the system responds with a binary data blob of raw decimated data for the specified requested data. If NO, then processing passes to step 618, where a determination is made whether the request is for image data.

If YES, then processing passes to step 619 where the system responds with a binary data blob of image data for the specified requested data. If NO, then processing passes to step 610, where the system responds with an error message indicating a problem. In this manner, different types of datasets may be loaded into the client machine, from a client request.

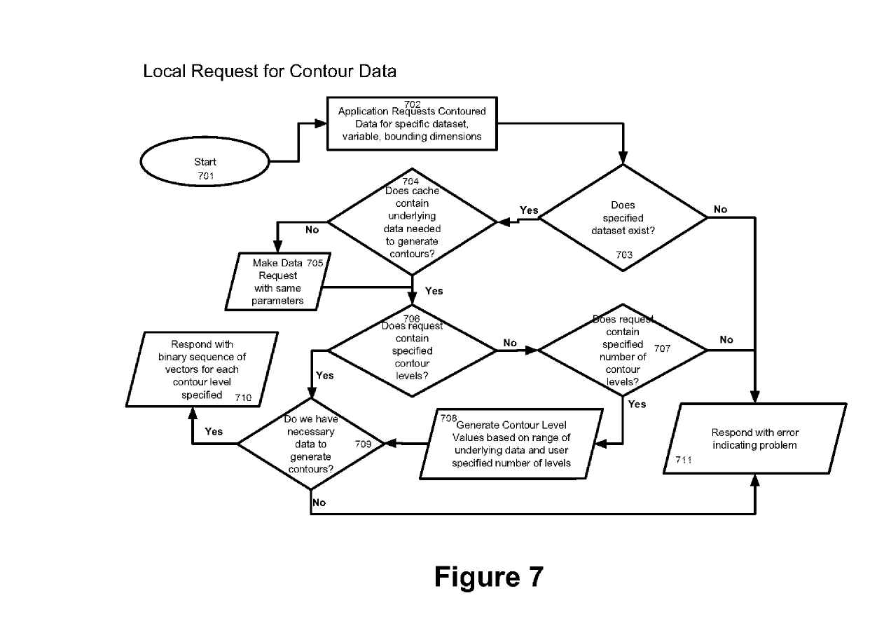

FIG. 7 is a flowchart illustrating the steps in a local request for contour data. Referring to FIG. 7, in step 701 the process is started. In step 702 the application requests contoured data for specific dataset, variable, and bounding dimensions. In step 703 a determination is made whether the specified dataset exists. If NO, then processing proceeds to step 711 where an error message is generated indicating a problem.

If YES, the processing passes to step 704 where a determination is made whether the cache contains underlying data needed to generate the contours. If NO, then processing passes to step 705 where a data request is made with the same parameters, in order to retrieve the necessary data into the cache.

If YES, processing passes to step 706 where a determination is made whether the request contains specified contour levels. If NO, then processing passes to step 707 where a determination is made whether the request contains a specified number of contour levels. If YES, then processing passes to step 708 as discussed in more detail below. If NO, then processing proceeds to step 711 where an error message is generated indicating a problem.

From step 707, if YES, then processing passes to step 708 where contour level values are generated based on the range of underlying data and user specified number of levels. Processing then passes to step 709, where a determination is made whether there is enough data to generate contours. If NO, then processing proceeds to step 711 where an error message is generated indicating a problem. If YES, then processing passes to step 710 where the system responds with a binary sequence of vectors for each contour level specified, thus completing the process.

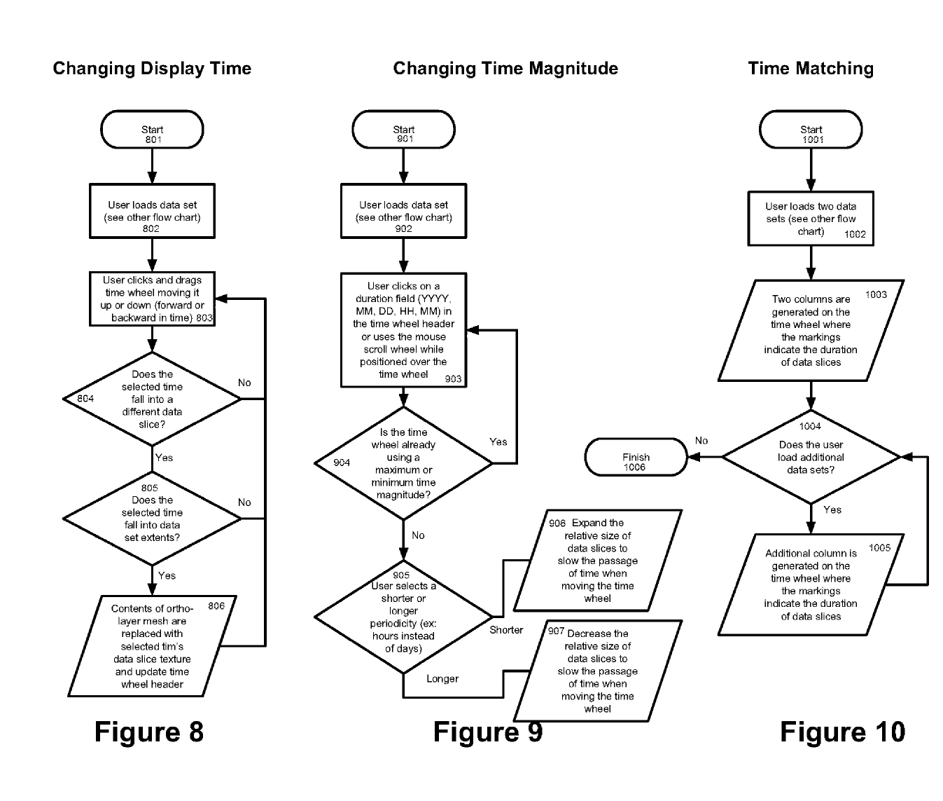

FIG. 8 is a flowchart illustrating the process for changing the display time. Referring to FIG. 8, in step 801 the process is started. In step 802, the user loads a data set (see the flow chart of FIG. 5). In step 803, the user clicks and drags the time wheel moving it up or down (forward or backward in time). In step 804 a determination is made whether the selected time falls into a different data slice. If NO, processing returns to step 803. If YES, processing proceeds to step 805 where a determination is made whether the selected time falls into data set extents. If NO, processing returns to step 803.

If YES, processing proceeds to step 806 where the contents of the ortholayer mesh are replaced with the data slice texture the selected times, and the time and wheel header are updated. Processing then returns to step 803.

FIG. 9 is a flowchart illustrating the process of changing the time magnitude. Referring to FIG. 9, in step 901 the process is started. In step 902, a user loads a data set (see the flow chart of FIG. 5). In step 903 the user clicks on a duration field (YYYY, MM, DD, HH, MM) in the time wheel header or uses the mouse scroll wheel while positioned over the time wheel. In step 904, a determination is made whether the time wheel is already using a maximum or minimum time magnitude. If YES, processing returns to step 903, as a maximum or minimum has already been reached. If NO, processing proceeds to step 905 user selects a shorter or longer periodicity (ex: hours instead of days).

If the user selects a shorter periodicity, processing proceeds to step 906 where the system expands the relative size of data slices to slow the passage of time when moving the time wheel. If the user selects a longer periodicity, processing proceeds to step 907 where the system decreases the relative size of data slices to slow the passage of time when moving the time wheel.

FIG. 10 is a flowchart illustrating the process of time matching. Referring to FIG. 10, in step 1001 the process is started. In step 1002, a user loads at least two data sets (see the flowchart of FIG. 5). Processing proceeds to step 1003 where two columns are generated on the time wheel where the markings indicate the duration of data slices. In step 1004, it is determined whether the user wishes to load additional data sets. If NO, then the process is finished in step 1005. If YES, then processing passes to step 1006 where an additional column is generated on the time wheel where the markings indicate the duration of data slices. Processing then passes top step 1004.

While the preferred embodiment and various alternative embodiments of the invention have been disclosed and described in detail herein, it may be apparent to those skilled in the art that various changes in form and detail may be made therein without departing from the spirit and scope thereof.

For example, while disclosed in the context of weather and climate modeling, the present invention may be applied to other types of data and research. For example, the present invention may be applied to other environmental data such as ecological, or ocean, or even social type data, without departing from the spirit and scope of the present invention. These data categories may be more generally described as physical, chemical, biological, or socioeconomic. These concepts can be applied to any data that can be geospatially or temporally located. For example, population and migration trends may be visually represented on a map, for humans or other species, and viewed over time. Thus, for example, the present invention may be used by biologists or naturalists to view migration trends or population trends among animals or humans. Socioeconomic trends may be similarly viewed, with data such as per capita income, health status, social status, or the like, being selectively viewed in terms of time and space. Thus, the present invention may have uses for sociologists, anthropologists, politicians and government officials in determining social or political trends over an area and over time.

We claim:

1. In an atmospheric data computer network, a method of interactively displaying four-dimensional geographic and atmospheric data, comprising the steps of:
generating geographic and atmospheric data from a plurality of geographic and atmospheric data sources;
transmitting the geographic and atmospheric data from the plurality of geographic and atmospheric data sources to a server configured to store and process the geographic and atmospheric data;
formatting, in the server, in response to request from a remote client computer, at least a selected portion of the geographic and atmospheric data into a four-dimensional visual data for display on a remote client computer, the four-dimensional visual data comprising a global display of geographic and atmospheric data in three dimensions over time;
transmitting the four-dimensional visual data to the remote client computer in response to the remote client request; and
displaying the four-dimensional visual data on the remote client computer, configured to selectively display selected portions of the four-dimensional visual data in response to remote client computer user inputs.

2. The method of claim 1, further comprising the steps of:
displaying a global view of at least a portion of the four-dimensional visual data on the remote client computer as visual data overlaid over at least a portion of a globe;
displaying a time wheel control on the remote client computer, the client computer being configured to allow a user to manipulate the time wheel control to provide the remote client user access to a temporal extent of overlays available in the four-dimensional visual data.

3. The method of claim 2, wherein the time wheel control is configured to allow the user perform one or more of the following functions:
change the time striding to step through time in minutes, hours, days, months, or other time intervals;
drag to change the time of the current overlay displayed;
as the time is changed the corresponding overlays associated with the current time bin are displayed to user;
set the time wheel to automatically advance through subsequent times determined by striding, overlays are updated accordingly; and
provide automatic advancement in either forward or reverse directions.

4. The method of claim 1, wherein the plurality of data sources comprise one or more of:
satellite weather data;
buoy data including wind direction and speed, temperature, barometric pressure, and water temperature;
weather station data including wind direction and speed, temperature, barometric pressure, and doppler radar data;
cloud radar data from remote cloud radar data stations; and
image data including satellite image data of the Earth's surface.

5. The method of claim 1, wherein:
at least a portion of the geographic and atmospheric data does not require additional processing;
the server is configured to collect metadata for that portion of the geographic and atmospheric data that does not require additional processing;
the portion of the geographic and atmospheric data that does not require additional processing remains on the corresponding plurality of geographic and atmospheric data sources; and
when the remote client computer requests data that does not require additional processing from the server by selecting from the metadata for that portion of the geographic and atmospheric data does not require additional processing, the server connects the remote client computer directly to corresponding geographic and atmospheric data sources to retrieve the portion of the geographic and atmospheric data that does not require additional processing.

6. The method of claim 2, further comprising the steps of:
displaying a global view of at least a portion of the four-dimensional visual data on the remote client computer as visual data overlaid over at least a portion of a globe;
displaying a height wheel control on the remote client computer, the client computer being configured to allow a user to manipulate the height wheel control to adjust to adjust altitude of displayed visual data.

7. The method of claim 5, wherein in response to a request from the remote client computer for geographic and atmospheric data for different spatial and temporal regions or ranges, the server processes and transmits the metadata for that geographic and atmospheric data to the remote client computer, which in turn requests corresponding geographic and atmospheric data directly from a corresponding data source, which in turn transmits four-dimensional visual data to the remote client computer, allowing a user of the remote client computer to display and scroll through the four-dimensional visual data visually, in both terms of space and time;
wherein if derivative data products are required to complete the request from the remote client computer, source geographic and atmospheric data from the data sources is downloaded to the server for processing into four-dimensional visual data.

8. The method of claim 3, wherein:
the four-dimensional visual data comprises at least a plurality of overlays, overlaid over a global geographical image; and
the plurality of overlays comprise a time series as a series of graphic images over time, and are automatically aligned in the remote client computer in chronological order and may be selectively displayed through use of the time wheel control on the remote client computer.

9. The method of claim 6, wherein the four-dimensional visual data comprises at least a plurality of overlays, overlaid over a global geographical image; the method further comprising the steps of:
the remote client computer queries the server providing the overlays to determine the temporal (time steps), and geospatial extents (vertical levels);
the server displays temporal and geospatial extents to a user on the remote client computer on the corresponding time wheel and height wheel;
the user selects, through the remote client computer using a corresponding one of the time wheel and height wheel, a desired time and vertical level, such that the remote client computer begins to load a corresponding overlay from the plurality of overlays for a specified vertical level by loading the closest overlays to the desired time from the plurality of overlays;
as each of the plurality of overlays are loaded and displayed to user on the remote client computer, a next grouping of additional overlays of the plurality of overlays, closest to a current time are loaded, and loading a next group of additional overlays is repeated until a percentage of memory available in the remote client computer is exhausted or an entire temporal extent selected by the user has been loaded;
when the user changes either the vertical level or the desired time to display, the process repeats using a current desired time and vertical level selected by the user on the remote client computer;
if memory on the remote client computer becomes exhausted, overlays furthest from the time or vertical level selected by the user is dynamically unloaded, keeping the maximum relevant data in memory and display on the remote client computer.

10. The method of claim 1, wherein:
the four-dimensional visual data comprises at least one overlay, overlaid over a global geographical image, where the at least one overlay is initially locked to the one or more of a vertical level, geospatial location, and time;
in response to a user input to the remote client computer, the at least one overlay is selectively unlocked and one or more of:
offset in a vertical extent such that a plurality of the at least one overlay are displayed at two or more vertical levels simultaneously,
offset in a temporal extent such that that a plurality of the at least one overlay are displayed at two or more time steps simultaneously,
offset in a geospatial extent such that that a plurality of the at least one overlay are displayed at two or more geospatial locations simultaneously, and
reset and locked back to one or more of the original vertical level, specified time, and geospatial location.

11. A system for aggregating and selectively displaying four-dimensional geographical and atmospheric, comprising:
a plurality of data sources providing geographical and atmospheric data;
a network, coupled to the plurality of data sources, receiving geographical and atmospheric data and transmitting the geographical and atmospheric data;
a server, coupled to the plurality of data sources through the network, and configured to receive, store and process the geographical and atmospheric data, the server configured to format, in response to request from a remote client computer, at least a selected portion of the geographic and atmospheric data into a four-dimensional visual data for display, the four-dimensional visual data comprising a global display of geographic and atmospheric data in three dimensions over time;
a remote client computer coupled to the server, receiving the four-dimensional visual data transmitted from the service in response to the remote client request from the remote client computer and configured to selectively display selected portions of the four-dimensional visual data in response to remote client computer user inputs.

12. The system of claim 11, wherein the remote client computer is configured to display a global view of at least a portion of the four-dimensional visual data as visual data overlaid over at least a portion of a globe and a time wheel control on the remote client computer; and
wherein the client computer is configured to allow a user to manipulate the time wheel control to provide the remote client user access to a temporal extent of overlays available in the four-dimensional visual data.

13. The system of claim 12, wherein the time wheel control in the remote client computer is configured to allow the user perform one or more of the following functions:
change the time striding to step through time in minutes, hours, days, months, or other time intervals;
drag to change the time of the current overlay displayed;
as the time is changed the corresponding overlays associated with the current time bin are displayed to user;
set the time wheel to automatically advance through subsequent times determined by striding, overlays are updated accordingly; and
provide automatic advancement in either forward or reverse directions.

14. The system of claim 11, wherein the plurality of data sources comprise one or more of:
satellite weather data;
buoy data including wind direction and speed, temperature, barometric pressure, and water temperature;
weather station data including wind direction and speed, temperature, barometric pressure, and doppler radar data;
cloud radar data from remote cloud radar data stations; and
image data including satellite image data of the Earth's surface.

15. The system of claim 11, wherein the server is configured to collect metadata for a portion of the geographic and atmospheric data that does not require additional processing and the server is configured to not load the portion of the geographic and atmospheric data that does not require additional processing onto the server, the portion of the geographic and atmospheric data that does not require additional processing remains on the corresponding plurality of geographic and atmospheric data sources; and
the server is configured such that when the remote client computer requests data that does not require additional processing, by selecting from the metadata for that portion of the geographic and atmospheric data does not require additional processing, the server is configured to connect the remote client computer directly to corresponding geographic and atmospheric data sources to retrieve the portion of the geographic and atmospheric data that does not require additional processing.

16. The system of claim 12, wherein the remote client computer is configured to display a global view of at least a portion of the four-dimensional visual data as visual data overlaid over at least a portion of a globe and a height wheel control on the remote client computer; and
wherein the client computer is configured to allow a user to manipulate the height wheel control to adjust to adjust altitude of displayed visual data.

17. The system of claim 15, wherein in response to a request from the remote client computer for geographic and atmospheric data for different spatial and temporal regions or ranges, the server processes and transmits the metadata for that geographic and atmospheric data to the remote client computer, which in turn requests corresponding geographic and atmospheric data directly from a corresponding data source, which in turn transmits four-dimensional visual data to the remote client computer, allowing a user of the remote client computer to display and scroll through the four-dimensional visual data visually, in both terms of space and time;
wherein if derivative data products are required to complete the request from the remote client computer, source geographic and atmospheric data from the data sources is downloaded to the server for processing into four-dimensional visual data.

18. The system of claim 13, wherein:
the four-dimensional visual data comprises at least a plurality of overlays, overlaid over a global geographical image; and
the plurality of overlays comprise a time series as a series of graphic images over time, and are automatically aligned in the remote client computer in chronological order and may be selectively displayed through use of the time wheel control on the remote client computer.

19. The system of claim 16, wherein the four-dimensional visual data comprises at least a plurality of overlays, overlaid over a global geographical image;
wherein the remote client computer is configured to query the server providing the overlays to determine the temporal (time steps), and geospatial extents (vertical levels);
the server is configured to display temporal and geospatial extents to a user on the remote client computer on the corresponding time wheel and height wheel;
the remote client computer is configured to allow a user to select, using a corresponding one of the time wheel and height wheel, a desired time and vertical level, such that the remote client computer begins to load a corresponding overlay from the plurality of overlays for a specified vertical level by loading the closest overlays to the desired time from the plurality of overlays;
the remote client computer is configured to load, as each of the plurality of overlays are loaded and displayed to user on the remote client computer, a next grouping of additional overlays of the plurality of overlays closest to a current time, and the process repeated until a percentage of memory available in the remote client computer is exhausted or an entire temporal extent selected by the user has been loaded;
the remote client computer is configured to repeat loading a next group of additional overlays when the user changes either the vertical level or the desired time to display, using a current desired time and vertical level selected by the user on the remote client computer;
the remote client computer is configured to dynamically unload overlays furthest from the time or vertical level selected by the user, if memory on the remote client computer becomes exhausted, keeping the maximum relevant data in memory and display on the remote client computer.

20. The system of claim 11, wherein:
the four-dimensional visual data comprises at least one overlay, overlaid over a global geographical image, where the at least one overlay is initially locked to the one or more of a vertical level, geospatial location, and time;
in response to a user input to the remote client computer, the at least one overlay is selectively unlocked and one or more of:
offset in a vertical extent such that a plurality of the at least one overlay are displayed at two or more vertical levels simultaneously,
offset in a temporal extent such that that a plurality of the at least one overlay are displayed at two or more time steps simultaneously,
offset in a geospatial extent such that that a plurality of the at least one overlay are displayed at two or more geospatial locations simultaneously, and
reset and locked back to one or more of the original vertical level, specified time, and geospatial location.
